(19) United States
(12) Patent Application Publication
(10) Pub. No.: US 2019/0381639 A1
(43) Pub. Date: Dec. 19, 2019

(54) Three Jaw Adjustable Socket Ratchet Wrench

(71) Applicant: Thomas Carnesi, Torrance, CA (US)

(72) Inventor: Thomas Carnesi, Torrance, CA (US)

(21) Appl. No.: 16/010,821

(22) Filed: Jun. 18, 2018

(51) Int. Cl. B25B 23/00; B25B 13/46; B25B 23/16; B25G 1/04

(52) U.S. Cl. CPC B25B 23/0028; B25B 13/463; B25G 1/043; B25B 23/16; B25B 23/0035

(57) ABSTRACT

A ratchet wrench assembly having an adjustable socket positioned above a main ratchet wrench, the adjustable socket being removable thus providing a separate main ratchet wrench sub-assembly.

### BACKGROUND OF THE INVENTION

### 1. Field of the Invention

The present invention relates to socket ratchet wrenches and, in particular, a wrench in which the handle is extendible and wherein the wrench is foldable for ease of storage.

### 2. Description of the Prior an

Adjustable socket wrenches have been widely available in the prior art.

For example, U.S. Pat. No. 5,421,225 to Chen describes a wrench having fixed and movable handles, each handle having recesses to store various tool bits. The fixed and movable handles can be turned to each other from a perpendicular relation to a parallel relation to a smaller size for convenient carrying and storage.

Although Chen describes a wrench having handles that can be arranged to have a smaller footprint, it is a device designed to provide one basic function.

What is desired is to provide a single socket wrench that has multiple functional capabilities.

### SUMMARY OF THE INVENTION

The present invention provides a unique socket ratchet wrench having a handle that can be extendable into two positions from the retracted position, the handle can be folded for storage and wherein the socket assembly is removable such that a flat wrench is available for use. Thus a single socket ratchet wrench has multiple capabilities allowing a user to perform varied functions using a single tool.

### DESCRIPTION OF THE DRAWINGS

For a better understanding of the present invention as well as other objects and further features thereof, reference is made to the following description which is to be read in conjunction with the accompanying drawing therein:

FIG. 1 is perspective view of the socket ratchet wrench of the present invention in a full retraction position;

FIG. 2 is a perspective view of the socket ratchet wrench of the present invention in a first extension mode:

FIG. 3 is perspective view of the ¾ inch and ¼ inch driver end attachment;

FIG. 4 is a left side profile view of the adjustable socket wrench of the present invention in the first extension mode;

FIG. 5 is a top view of the adjustable socket wrench shown in FIG. 4;

FIG. 6 is a cross-sectional view of the wrench shown in FIG. 4 along line 6-6 of FIG. 5;

FIG. 7 is a bottom view of the wrench shown in FIG. 4;

FIG. 8 is a perspective view of the socket wrench in FIG. 1 in the fully retracted position and folded 90 degrees for storage;

FIG. 9 is a left side view of the socket wrench of the present invention in a plus 30 degree angle at the second extension position;

FIG. 10 is a left side profile view of the socket wrench of the present invention in minus 30 degree angle at the first extension position;

FIG. 11 is an exterior profile of the adjustable socket of the socket shown in FIG. 1;

FIG. 12 is a cross-sectional view along line 12-12 of FIG. 11 of the adjustable socket showing the intake of the socket jaw housing;

FIG. 13 is a left side view of the ratchet wrench shown in FIG. 2 in the first extension position;

FIG. 14 is a bottom view of the ratchet wrench shown in FIG. 13;

FIG. 15 is an aft perspective view of the adjustable socket wrench shown in FIG. 13 with the adjustable socket in the first extension position;

FIG. 16 is a perspective view of the fully assembled adjustable socket wrench in the first extension mode detached from the extendible socket wrench;

FIG. 16a is a perspective aft view of the fairy assembled adjustable socket ratchet wrench in the first extension mode.

FIG. 17 is a top view of the adjustable socket jaw housing wife the jaw adjusted to a ⅝ inch totem size;

FIG. 18 is a top view of the adjustable socket jaw housing adjusted to a 7/16 fastener size;

FIG. 19 is a sectional view of the adjustable jaw housing descending to provide a large hexagonal size opening.

FIG. 20 is a sectional view similar to FIG. 19 with the jaw members adjusted and elevated to a hexagonal size opening smaller than what is provided by the jaw-setting shown in FIG. 19;

FIG. 21 is a partial sectional view with the jaw members adjusted and descended to a large hexagonal size opening;

FIG. 22 is a partial sectional view similar to FIG. 21 with the jaw members adjusted and elevated to a hexagonal size opening smaller than what is provided by the jaw setting shown in FIG. 21;

FIG. 23 is a sub-assembled view of one ratchet jaw;

FIG. 24 is an exploded view of FIG. 23:

FIG. 25 is a cross-sectional view along line 25-25 of FIG. 23 and

FIG. 26 is an exploded view of die adjustable socket wrench of the present invention.

### DESCRIPTION OR THE INVENTION

Referring now to FIG. 1, a perspective view of one embodiment of the present invention is illustrated. In particular, a three jaw adjustable socket ratchet wrench 10 is shown with handle 12 in the full retraction position (as will be set forth hereinafter, handle 12 has two additional positions). Handle 12 has a knurled end 14, a pivotal end portion 16 and adjustable socket 20. A conventional hex bolt 22 is captured by jaws 24 of socket 20 (although three jaws are illustrated, additional jaws can be used) when the jaws are appropriately positioned is illustrated.

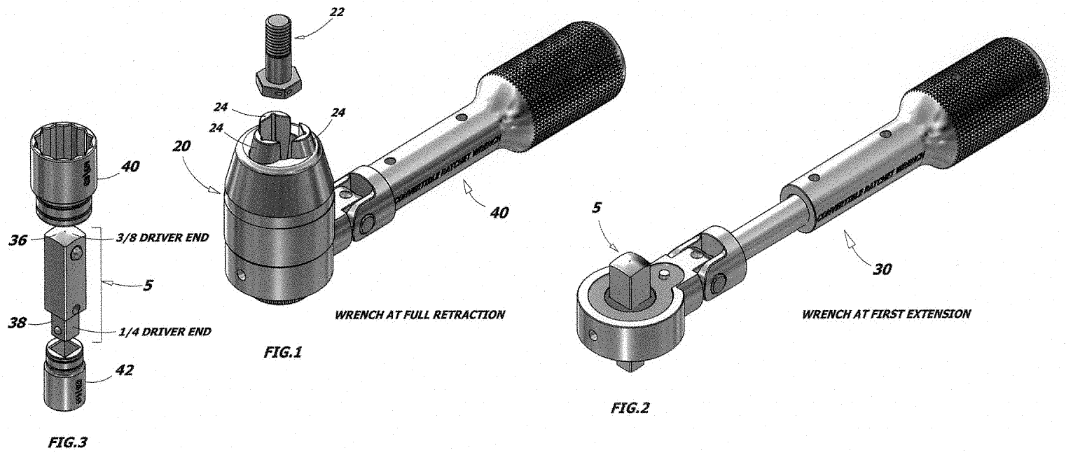

FIG. 2 is a perspective view of a second embodiment of the present invention. In particular, wrench 30 with the adjustable socket 20 removed (main ratchet wrench sub-assembly) handle 12 is shown in the first extension mode. Wrench bead 32 has driver attachment 33 (¼ inch size) inserted securely into a lower opening and driver attachment 34 (⅜ inch size) securely inserted into opening 36.

FIG. 3 illustrates the ⅜ and ¼ driver adapter. Three retention dowel pins 6c connect jaw housing 2b to the lower driver 6a and the lower driver with fasteners part 6c. Three horizontal holes 6b and 6c receive fasteners that connect both jaw housing 2 and lower adjustable socket driver 6 together.

The ⅜ square stem on the lower portion of the lower driver embodiment 6a mates with the ratcheting gear female square hole 14b (14 is the main ratcheting gear) and the serrated ratcheting outer teeth 14a on the main gear 14.

Two holes retain both the square stem 6d which fits into 14b female square slot 14b of ratcheting gear 14.

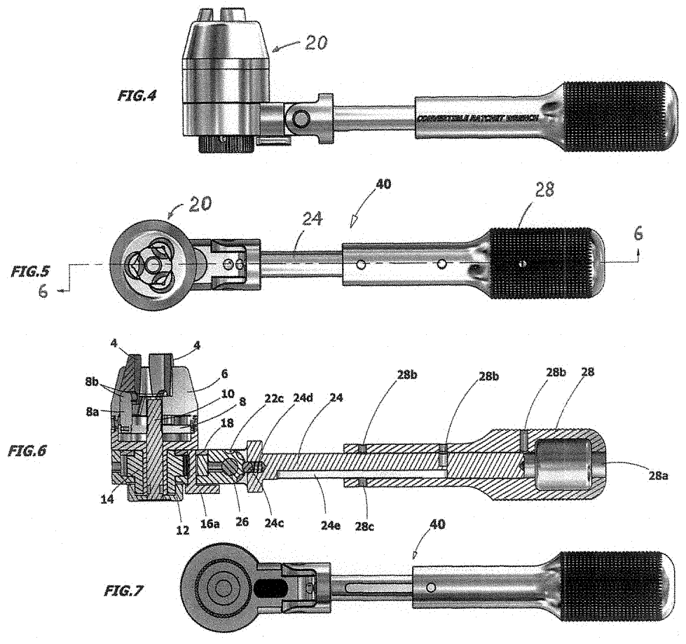

FIG. 4 is a side view of the first embodiment of wrench 10 (with adjustable socket 20 attached to the underlying wrench shown in FIG. 2) in its first extension position and FIG. 5 is a top view of the wrench shown in FIG. 4. Apertures 23 and 25 are adapted to receive ball hearings 28a and 28b positioned on shaft 24.

FIG. 6 is a cross-sectional view of wrench 10 along line 6-6 of FIG. 5 and illustrates the details of the wrench components. In this view, ball bearing 28b engage a Stop member in handle 12 to maintain wrench 10 in its first extension position.

FIG. 7 is a bottom view of the wrench 10 shown in FIG. 6 and FIG. 8 shows wrench 10 in the fully retracted position and folded at a 90 degree angle to allow the wrench to be easily stored after or before use.

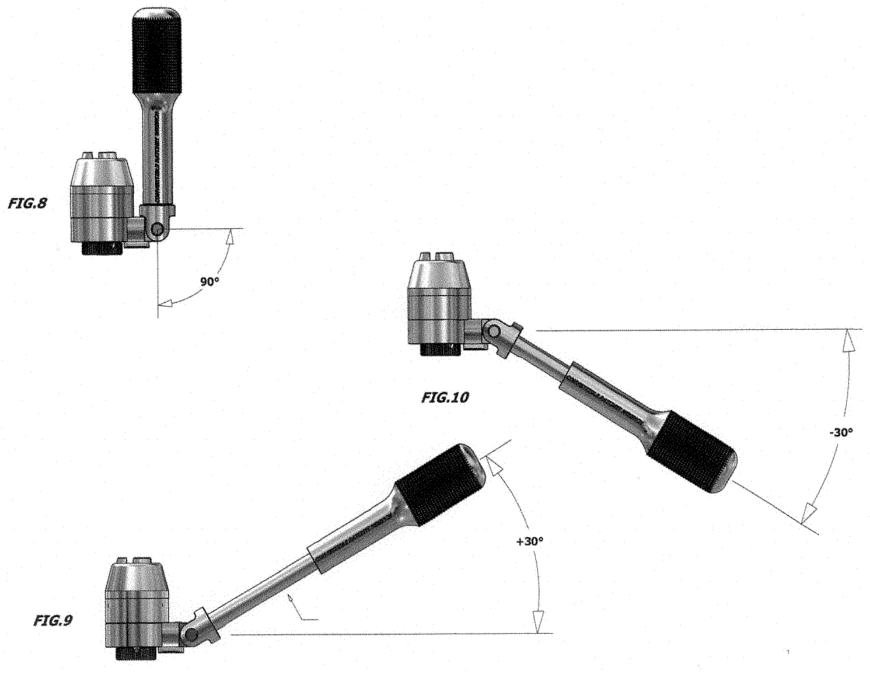

FIG. 9 illustrates the embodiment of wrench 10 with the adjustable ratchet 20 at the second extension position (ball bearing 28a functions to keep handle 12 in that position) and at a 30 degree positive angle to the horizontal; FIG. 10 is similar to FIG. 9 with the wrench 10 being at the first extension position and handle 12 at a negative 30 degree angle to the horizontal.

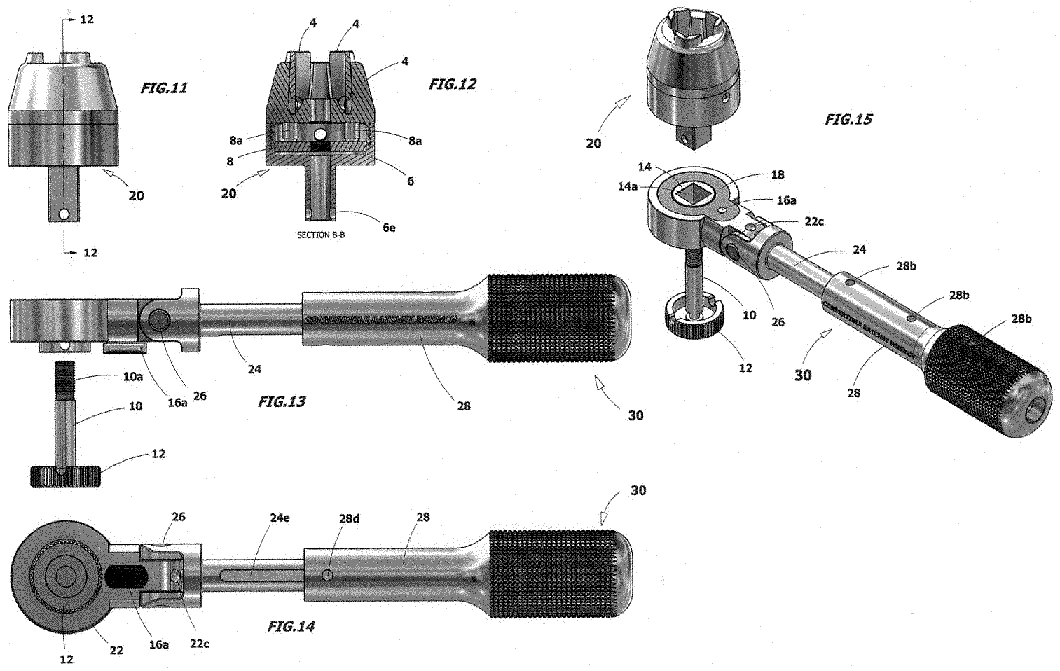

FIG. 11 is a perspective view of the adjustable socket 20 illustrating cylindrical extension 31 having an aperture 32 and FIG. 12 is a cross-sectional view along line 12-12 of FIG. 11. FIG. 12 shows jaw members 4 (three total), jaw adjusting cylindrical disk 50, the bottom portions of pillars 52, lower adjustable socket driver 56 and receiving apertures 58.

FIG. 13 is a left side view of the ratchet wrench 30 (adjustable socket wrench 20 removed from assembly 10), main adjusting thread screw 60 having a thread 62 formed at one end and knurled adjusting knob 64 at the other end. Also shown is retching pawl 68, main ratchet wrench flexing arm 24, dowel pin 70 for connecting the main ratcheting head 72 to flexing arm 24 and the slidable arm cylinder 12 with knurled grip 14.

FIG. 14 is a bottom view of the ratchet wrench shown in FIG. 13 and FIG. 15 is a perspective view of the adjustable socket 20 detached from the ratchet wrench 30 resulting in the driver wrench tool embodiment of the present invention. Adjustable socket 20 is attachable to the driver wrench head 72 by inserting bar 31 into aperture 80.

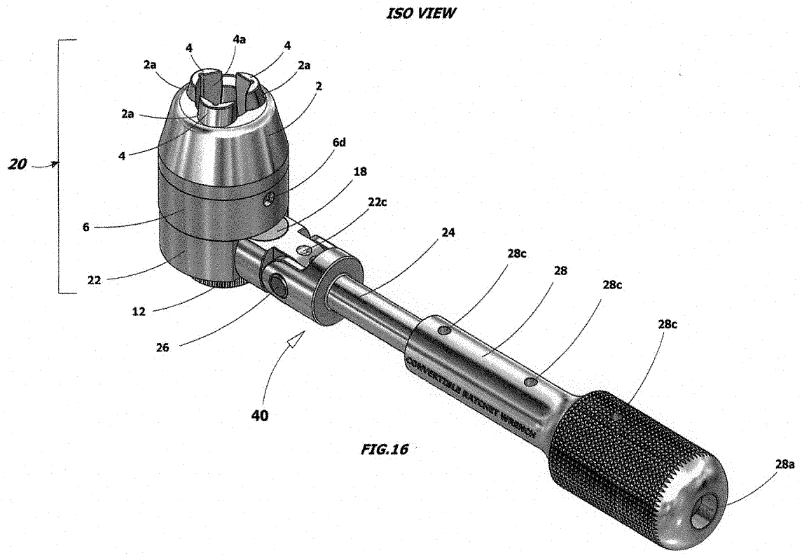

FIG. 16 is a frontal perspective view of the fully wrench shown in FIG. 15.

FIG. 16a is a perspective view of the wrench 10 of the present invention with ratchet socket 20 attached to head 72 of the driver wrench, flex arm 24 being in the first extension position.

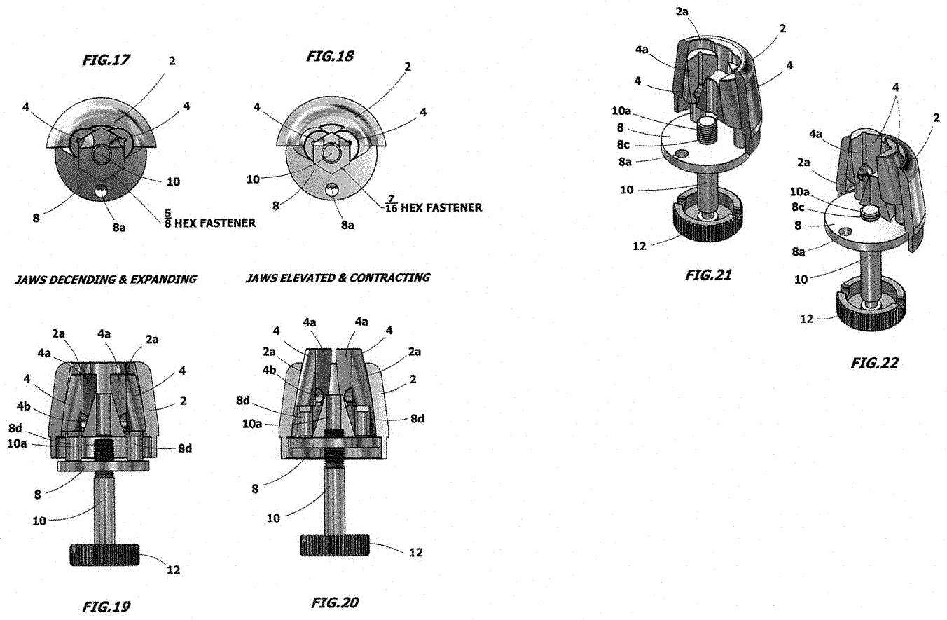

FIG. 17 is a top view of the adjustable socket's jaw housing showing two adjacent jaws 4 and elevation and descending control disk 8 with the jaws configured to receive a ⅝″ fastener and FIG. 18 is a top view of the adjustable socket's jaw housing showing two adjacent jaws 4 and elevation and descending control disk 8, the jaws being configured to receive a 7/16″ fastener.

FIG. 19 is a view of the adjustable socket jaw housing 20, two adjacent jaws 4, jaw actuator 6, elevations) and descending ring 8, two jaw adjusting ring connecting pillars 92 and central main adjusting threaded screw 60 and exterior knob 64. The two jaw members 4 are illustrated as defended to a large hexagonal size opening to receive a corresponding sized fastener.

FIG. 20 is similar to FIG. 19 wish the knob 64 rotated in a manner to move jaw members 4 to a hexagonal size opening smaller than that shown in FIG. 19 to receive a corresponding sized fastener.

FIG. 21 is a perspective, sectional view of the jaw housing of adjustable socket 20 corresponding to FIG. 19 and FIG. 22 corresponds to the structure shown in FIG. 20. Note that the rotation of knob 64 causes threaded end 62 to move vertically up or down causing ring 8 to move correspondingly up or down which in turn raises the pillars up or down. This movement causes jaws 4 to move upwardly or downwardly, the jaws moving at a slight angle.

FIG. 23 is a view of a single jaw member 4, jaw connecting pillar 8 and adjusting elevation and descending ring 8 together.

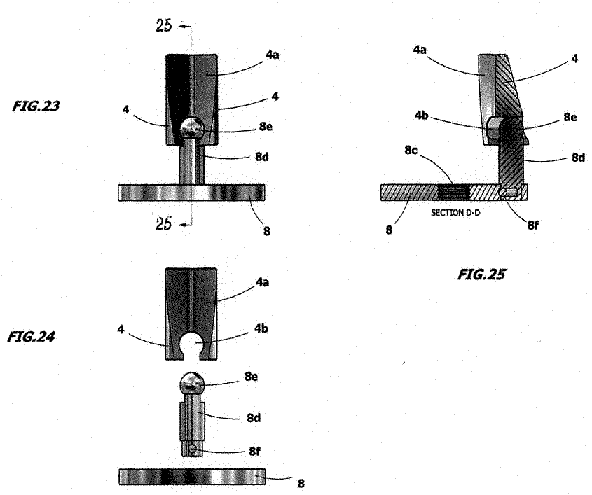

FIG. 24 is an exploded assembly view of the jaw member shown in FIG. 23 and FIG. 25 is a cross-sectional view of the jaw member shown in FIG. 23.

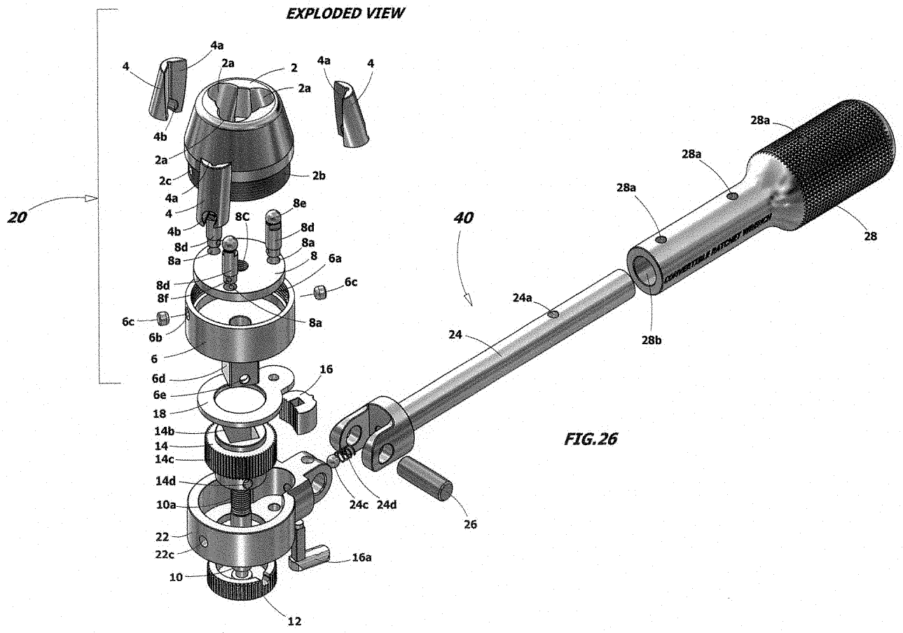

FIG. 26 is an exploded view of wrench 10.

FIG. 26 is an exploded view of adjustable socket ratchet wrench 10. The adjustable socket 20 component comprises jaw housing 50, jaw members 52, lower adjustable socket driver 54, jaw adjusting and cylindrical disk 56. Additional components comprise main adjusting thread screw 60, exterior adjusting knurled knob 62, main ratching gear 64, main ratching pawl 66, ratching pawl reverse and forward lever 68, ratching head protective cover 70, main ratchet head 72, main ratchet wrench flexing arm 74 and dowel pin 76 for connecting the main retching head to the flexing arm 74. Hexing arm 74 includes apertures 76, internal shaft 78, movable pin 80, flexing arm 74 being insertable into opening 82 formed in shaft portion 84.

The three vertical 15 degrees tapered cylindrical bores 2a are formed within jaw housing 2 where the three jaws 4 ride up or down when activated by the threaded main vertical screw 14c. Jaw 4a is the interior 120 degrees V-slot which become a hexagonal configuration when the three jaws are approaching triangularly and abutted to each other to accept any hexagon size fasteners within the range, item 4b is the bottom jaw whole diameter and bottom horizontal slot to accept spherical ball feature 8d and 8e on top of the pillar 8a. The three jaws are equally spaced 120 degrees attach vertical holes on actuator disk 8 pillar to accept the three pillars 8d that are press fitted into disk 8 three vertical holes (see FIGS. 23 and 24.

The present invention thus provides a versatile ratchet wrench tool which includes the following novel features:

1. A handle member that has a retracted position, a first extended position and a second extended position;

2. A hinge arrangement whereby the end of the tool can be folded such that the tool can easily be stored; and

3. The capability of converting the tool from a one having an adjustable socket to one having a fixed ratchet wrench easily.

Further details of the present invention follows.

Component 26 is the ¼ diameter×¾ inch length dowel pin which connects the ratcheting bead 20 to the solid swivel arm 24. Swivel Arm 24 is flexible, and is locked into selected radical position through the detent nodes 22c which are spaced 180 degrees straight, +45 degrees upward, +90 degrees upward and −45 degrees downward with the aid of a spring loaded steel ball bearing 24c compressed by spring 24d.

In order to convert, the embodiment 20 to embodiment 5, the user unscrews the threaded set screw 10 adjusting knurled screw 12. The user utilizes a 1/16 inch hex wrench and unscrews the internal set screw until it is removed; the adjustable socket 20 is removed by pulling it upwards. The embodiment 5 is installed by compressing the attachment downward until it snaps into place via spring loaded detent ball 32.

The user interchanges adjustable socket 20 or embodiment 5 at their discretion when the job requirement is called for: embodiment 5 is for the use if either a ¼ drive individual socket of a particular size at the lower end (FIG. 3) or a ⅜ drive individual socket 40 of a selected size at top end 36 of a particular size needed. The ¼ lower driver end is adaptable to be used, for example, with a universal Phillips screwdriver attachments and other configured fastener attachments and extensions for special tasks.

The above features enable the user to perform a number of wrenching operations with a single tool, thus reducing the cost of doing so. In particular, a user can be at a job site and then determine what wrenching tool is required, i.e. either one having an adjustable socket or one requiring a driver bead. Further, the tool can reach difficult wrenching areas by having adjustable handle positions.

While the invention has been described with reference to its preferred embodiments, it will be understood by loose skilled in the an that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A ratchet wrench tool comprising:
a handle member having first and second ends;
an adjustable socket removably attached to said first end for securing a fastener member;
a main ratchet wrench positioned below said adjustable socket;
said handle being extendable from a retracted position to first and second extended positions, such second extended position resulting in the tool having a predetermined length; and
pivot points to enable said handle to be rotated to a position smaller than said predetermined length.

2. The ratchet wrench of claim 1 wherein said adjustable socket is removed from said first end, thus providing a ratchet wrench subassembly.

3. The ratchet wrench of claim 2 wherein said ratchet wrench subassembly has upper and lower ends, a first driver being formed at said upper end and a second driver being formed at the said lower end.

4. The ratchet wrench of claim 3 wherein said main ratchet wrench is pivotably connected to said handle.

5. The ratchet wrench of claim 4 wherein a screw set is provided to couple the main ratchet wrench to said adjustable socket.

6. The ratchet wrench of claim 5 where said adjustable socket includes rotatable disk member and a surface containing a plurality of pillar type members.

7. The ratchet wrench of claim 6 further including a plurality of jaw members having upper and lower ends, user rotation of said disk member causing said jaw members to a position towards or away from each other.

8. The ratchet wrench of claim 7 wherein the position of said jaw members is determined by the dimensions of said fastener member.
